(19) United States
(12) Patent Application Publication
(10) Pub. No.: US 2008/0072106 A1
(43) Pub. Date: Mar. 20, 2008

(54) Method and system of specifying semantics of a late trigger

(76) Inventor: Bruce Hamilton, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/523,600

(22) Filed: Sep. 20, 2006

(51) Int. Cl. G06F 11/00

(52) U.S. Cl. 714/51

(57) ABSTRACT

In a computer programming language environment operating with a real-time clock, a method comprises: providing an instruction in the programming language for performing an action and for specifying an explicit time for performing the action, the instruction including at least a first parameter for specifying whether the action should be performed in a case where the real-time clock indicates that the specified explicit time when the action is to be performed has passed; and providing a means for at least one of (1) signaling an error, and (2) specifying a function to be performed, in a case where the real-time clock indicates that the specified explicit time when the action is to be performed has passed.

### BACKGROUND

Most known existing computer programming and other machine-control languages and associated systems do not allow a programmer to specify an explicit or absolute time-of-day within the programming language. Instead, they deal with time implicitly. That is, they provide the ability to trigger an event “now,” or in relationship to when another event occurs (e.g.: “when a pulse appears on the ‘Sync IN’ connector;” “two clock cycles after a FLAG is set;” or “250 microseconds after you get this message;” etc.).

In such a system, it is possible to state that an action is to occur in the past (e.g., “250 microseconds before you get this message”), but such an instruction violates causality and of course cannot be performed. And the intended time for the action cannot be stated explicitly. That is, it is not possible to specify that an action is to be triggered at 3:01 PM on 8 Jun. 2007 if the time of an event can only be specified as an offset from another event. For these reasons, in general there has been no effort to specify the exact semantics of such a request, i.e., exactly what is supposed to happen when an operation is to be performed at a particular time, but that time has already passed.

Meanwhile, there are also difficulties involved in detecting when a late-trigger situation occurs. For example, suppose that a program reads the clock time before requesting an action, and determines that the time for the action to be triggered is definitely in the future. The program may be pre-empted by some other task before it can then trigger the action. Even if there was a way to detect that the action had been pre-empted, so that the program could re-read the clock time, we might again find that there is enough time and proceed to schedule the action, only to be pre-empted again. So it is impossible to tell, before scheduling the action, whether it will actually be performed on time. This makes it difficult to implement the exact semantics of “don't perform the action if it's too late.”

Indeed, it is even difficult to detect if an error has occurred. If a program looks at the clock time after scheduling an action and sees that the time has passed, it might have been too late, but it is also possible that it was scheduled in time and the action was performed at the proper time, but the program was pre-empted between the time it scheduled the action and the time it read the clock. So the program may think that there was an error, but there wasn't.

These are considered to be “facts of life” in existing systems and programming languages, and are thus not considered “problems.” Thus, in these systems and languages, no solutions exist.

However, this lack of expressive power is a weakness. If programs could specify those things and run-time environments could implement them, programmers could state their intent more directly and clearly, and their programs would be easier to debug and maintain.

What is needed, therefore, is a method and system of specifying the semantics of a late trigger. In more detail, what is need is such a method and system that specifies such semantics for an operating environment with a real-time clock.

### SUMMARY

In an example embodiment, a method controls the activities of a computer-based instrument containing a real-time clock and running one or more software routines. The method comprises executing a software triggering routine controlling a specific hardware operation, wherein the software triggering routine is structured to receive one or more parameters specifying the semantics of the triggering routine. The one or more parameters include at least one of: a first parameter for specifying a specific error code of the software triggering routine should the real-time clock indicate that the computer-based instrument is late in executing the triggering routine; and a first control parameter specifying whether the computer-based instrument will execute or cancel the specific hardware operation should the real-time clock indicate that the computer-based instrument is or would be late in executing the software triggering routine.

In another example embodiment, a method operates in a computer programming language environment operating with a real-time clock. The method comprises: providing an instruction in the programming language for performing an action and for specifying an explicit time for performing the action. The instruction includes at least a first parameter for specifying whether the action should be performed in a case where the real-time clock indicates that the specified explicit time when the action is to be performed has passed; The instruction provides a means for at least one of (1) signaling an error, and (2) specifying a function to be performed, in a case where the real-time clock indicates that the specified explicit time when the action is to be performed has passed.

In yet another example embodiment, a computer-based system comprises memory; and a processor configured to execute one or more algorithms in response to instructions stored in the memory and written using a programming language configured to operate with a real-time clock. The algorithm includes: an instruction in the programming language for performing an action and for specifying an explicit time for performing the action, the instruction including at least a first parameter for specifying whether the action should be performed in a case where the real-time clock indicates that the specified explicit time when the action is to be performed has passed; and a means for at least one of (1) signaling an error, and (2) specifying a function to be performed, in a case where the real-time clock indicates that the specified explicit time when the action is to be performed has passed.

In still another example embodiment, a method operates in a system operating with a real-time clock. The method comprises providing an instruction for performing an action and for specifying an explicit time for performing the action, the instruction including at least a first parameter for specifying whether the action should be performed in a case where the real-time clock indicates that the specified explicit time when the action is to be performed has passed; and providing a means for at least one of (1) specifying whether the action should be performed, and (2) specifying any other action to be taken, in a case where the real-time clock indicates that the specified explicit time when the action is to be performed has passed.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a diagram illustrating one embodiment of a system that may employ a computer programming language that supports an instruction for performing an action at an explicit time;

FIG. 2 is a more detailed function block diagram of one embodiment of a controller that may be employed in the system of FIG. 1;

FIG. 3A illustrates one embodiment of a syntax of an instruction for performing an action at an explicit time;

FIG. 3B illustrates a second embodiment of a syntax of an instruction for performing an action at an explicit time;

FIG. 3C illustrates a third embodiment of a syntax of instruction for performing an action at an explicit time;

FIG. 3D illustrates a fourth embodiment of a syntax of instruction for performing an action at an explicit time;

FIG. 4 is a flowchart of one embodiment of an algorithm employing an instruction for performing an action at an explicit time.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

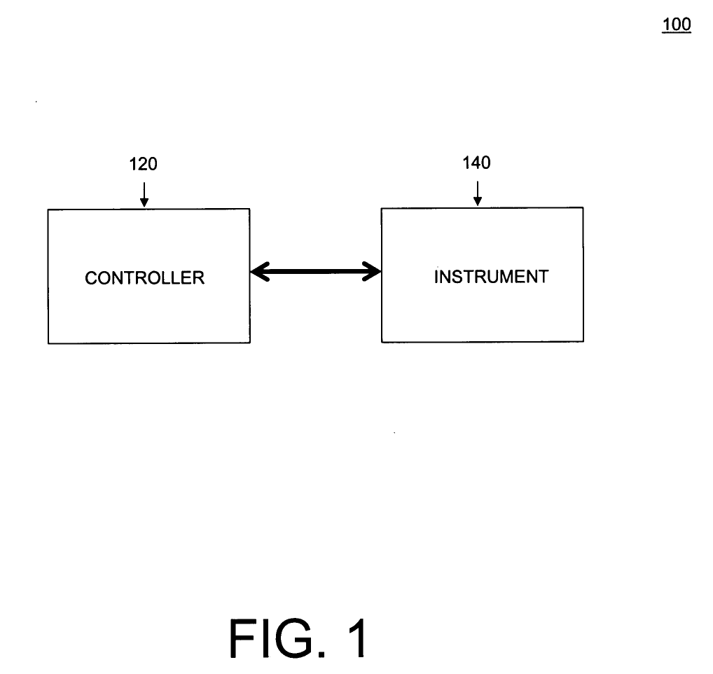

FIG. 1 illustrates one embodiment of a system 100 that may employ a computer programming language that supports an instruction for performing an action at an explicit time. The system 100 includes a controller 120 and an instrument 140. It is important to note that FIG. 1 is only one exemplary embodiment that will be used in the discussion to follow to better illustrate various aspects of a method and system providing semantics of a late event for an instruction for performing an action at an explicit time. For example, the method and system can also be employed in an embodiment where a single standalone computer processor (e.g., a personal computer) executes various software routines employing a computer programming language that supports an instruction for performing an action at an explicit time, without any instrument or externally monitored device.

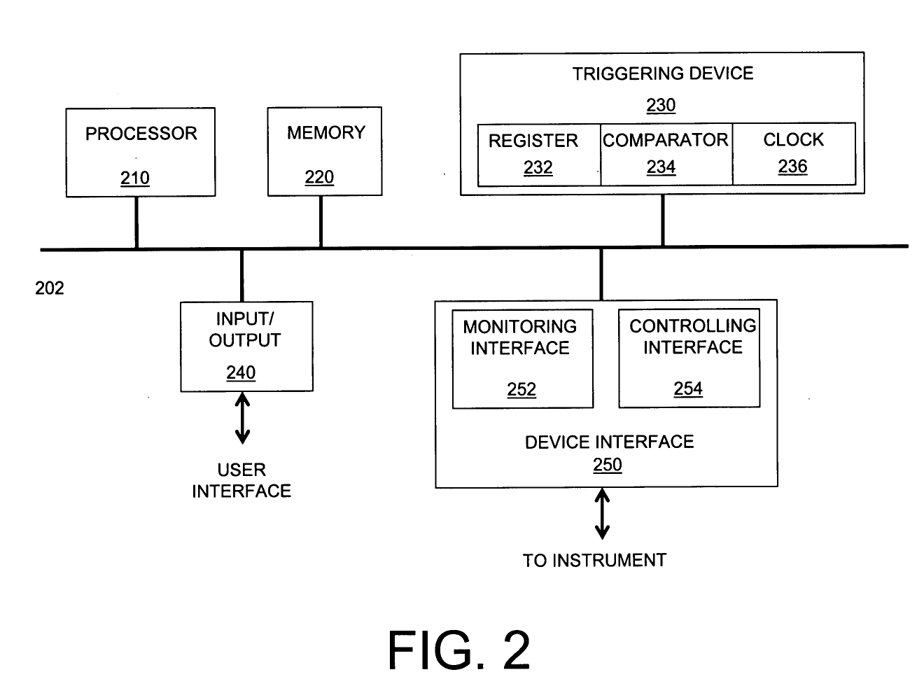

In the system 100, controller 120 monitors and/or controls instrument 140. [00023] FIG. 2 illustrates one embodiment of controller 120 that can be employed in system 100. Controller 120 includes processor 210, memory 220, triggering device 230, input/output (I/O) connection 240, and device interface 250, all connected by a data bus 202. Triggering device 230 includes comparator 234, register 232, and real-time clock 236. Device interface 250 includes monitoring interface 252 and controlling interface 254. Again, the embodiment of FIG. 2 is only one exemplary embodiment that will be used in the discussion to follow to better illustrate various aspects of a method and system providing semantics of a late event for an instruction for performing an action at an explicit time. In other embodiments, various elements may be omitted, particularly device interface 250.

In operation, memory 220 stores executable code in designated memory locations. Processor 210 executes a software algorithm in accordance with the machine code stored in memory 220. The software algorithm executes instructions provided in a programming language used to construct the software algorithm. As described in more detail below, the programming language is configured to operate with real-time clock 236, and provides the ability to specify that an action is to be performed at an explicit time. In that regard, triggering device 230 employs real-time clock 236 to provide a running update of absolute time. In that case, when executing an instruction to schedule an action to be performed at an explicit time, the scheduled time, T_{S}, for the action to be performed is loaded into register 232. Comparator 234 compares the clock time from clock 236, T_{CLOCK}, against the scheduled time T_{S} stored in register 232, and when the times are the same, then comparator 234 generates a hardware trigger signal (an edge, typically) and sends the trigger signal to the circuit to be activated. For example, where the action is to be performed by instrument 140 of FIG. 1, then the trigger signal for the action may be provided to device interface 250). In that case, driver interface 250 may pass the trigger signal across controlling interface 254 to instrument 140 for the action to be performed.

In practice, clock 236 advances at the granularity of the underlying crystal, so the scheduled time stored in register 232, T_{S}, may fall between “ticks.” Thus, it is necessary for comparator 234 to check if the clock time from clock 236, T_{CLOCK}≧T_{S}, the scheduled time, rather than merely checking to see if the T_{CLOCK}=T_{S}. That means, however, that once the scheduled time T_{S} is reached, comparator 236 will generate the hardware trigger signal on every subsequent clock tick. This is not what was intended. To address this issue, additional circuitry (not shown) is employed to make the action occur only once. One embodiment uses the output of the comparison to turn off an “enable bit” that causes the comparison to occur. In another embodiment, the circuit implements a small state machine, and outputs an edge if the T_{CLOCK}<T_{S}, on one clock tick and T_{CLOCK}≧T_{S}, on the next clock tick.

Because the system 100 has the ability to specify a trigger at an explicit time (e.g., 3:01 PM on 8 Jun. 2007), then the notion of a trigger in the past becomes meaningful, and there are even realistic cases in which it might occur. For example, suppose a program intends to set a trigger in the near future—say 20 milliseconds from now. If the current time is 9:07.061 then the program will calculate that the action should occur at 9:07.081. Now suppose that just before setting that trigger, the program is pre-empted by a high-priority task for 21 milliseconds. When the program resumes execution and sets the trigger, the time is now 9:07.082. So at this point, the program is waiting to schedule an event in the past.

How should the program be designed to handle this situation? The answer depends upon the specific circumstances. Consider the following four scenarios, each of which presents a different answer to that question.

Scenario One. Consider a case where the program is controlling a device to sample a short-lived event. For example, consider a program that controls a device to weigh a can as it passes by on a conveyor belt. In this case, if the scheduled action is performed later, it will produce an incorrect result. So an error should be signaled. However, downstream software may be aligning this data stream with others, so the device should still take the measurement and send it to the subsequent algorithms where it is normally used. So, scenario one involves situations where we want the operation to be performed even if slightly late, but where the late timing may lead to errors or problems in subsequent processes if it is not acknowledged and accounted for, and so an error should be signaled

Scenario Two. Consider a program that controls a valve on a tank to close the valve after emptying the tank. In this case if the scheduled action is performed a little late, in general there is no harm. So if the scheduled time for performing the operation has just passed and the operation has not yet been performed, then the action definitely should still be performed. Also, in that case, since there is no harm to anyone from the valve closing slightly late, no error should be signaled. So, scenario two involves situations where we want the operation to be performed even if slightly late, and where the late-timing of the operation is not going to cause problems for subsequent processes, and so we do not want to signal an error.

Scenario Three. Consider a program that controls a device to drop a cutting blade to separate finished parts moving along a conveyer belt. In this case, if the scheduled action is performed a little late, it will not only fail to achieve its objective, it will likely damage one or more finished parts. So if the scheduled time for performing the operation has just passed and the operation has not yet been performed, then the action definitely should not be performed. Also, in that case, an error should be signaled. So, scenario three involves situations where we do NOT want the operation to be performed even if slightly late, and where we want to signal an error.

Scenario Four. Consider a program that controls a device to sweep the crumbs out of a bakery oven after the bread is removed each time a new batch is baked. In this example, assume that the process has five seconds to perform the operation before the next batch is loaded into the oven. In that case, if a command to the device is four seconds late, then the operation should not be started as it will not have time to complete within the five second time window. Furthermore, since the operation is not essential and the oven presumably will be swept after the next batch is baked anyway, signaling an error may be costly if it stops a continuous process.

Another example of Scenario Four is when performing an operation late is harmless in and of itself, but it is wasteful or expensive. For example, consider a program that controls the timing of flashing a strobe light for a camera. If the strobe light is flashed after the camera has already taken a picture, it will not harm the picture-taking process, but it wastes battery power. Again, in this case the operation should not be performed. If an operation is not essential (because it is redundant, or subsequent steps can pick up what is missed, etc.) then a programmer may want not to signal an error even though the timing for the operation was late. So scenario four involves situations where we do NOT want the operation to be performed even if slightly late, and where it is desired not to signal any error.

Table 1 below illustrates the four scenarios described above.

TABLE 1

| Scenario | Perform Action? | Signal Error? |
|---|---|---|
| 1 | Yes | Yes |
| 2 | Yes | No |
| 3 | No | Yes |
| 4 | No | No |

To address these situations and issues, a system and method are provided that allow a programmer to specify all the desired semantics. In particular, in the embodiments of FIGS. 1 and 2, memory 220 may store at least one instruction that specifies semantics for a late trigger. The instruction includes at least one of: (1) a first parameter for specifying whether an action should be performed in a case where real-time clock 236 indicates that the specified explicit time when the action is to be performed has passed; and (2) a parameter for specifying whether or not to signal an error, and/or specifying an operation to be performed, in a case where real-time clock 236 indicates that the specified explicit time when the action is to be performed has passed. In that case, at the appropriate point(s) in an algorithm, processor 210 executes the instruction in conjunction with triggering device 230.

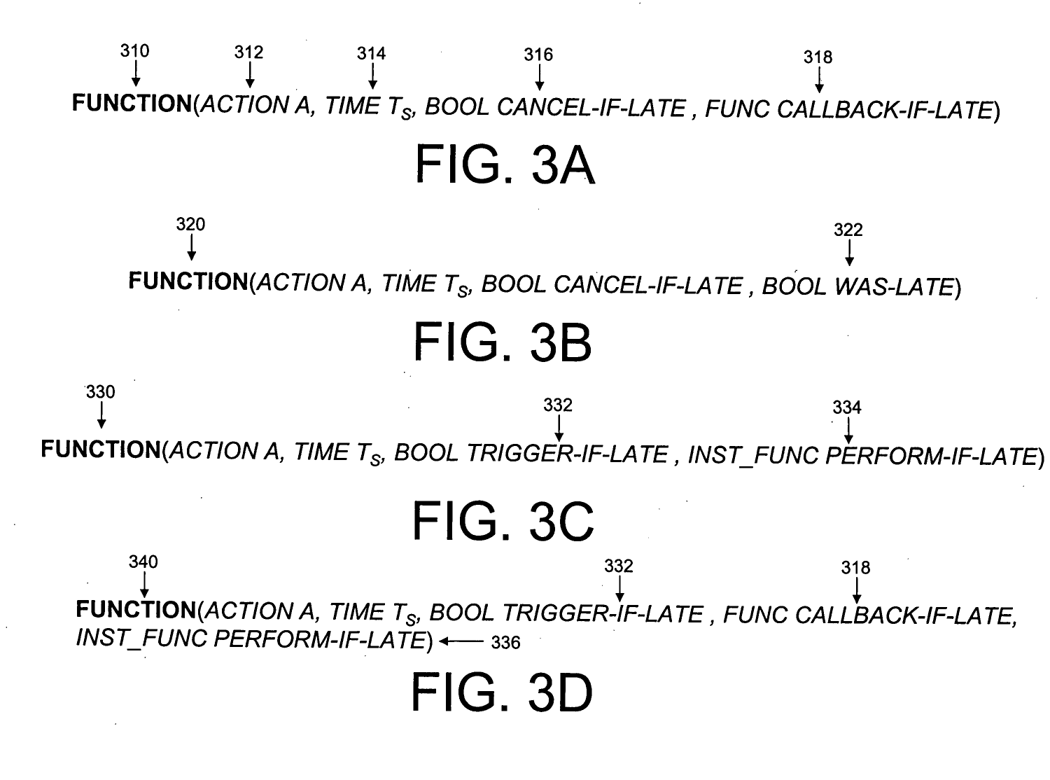

FIG. 3A illustrates one embodiment of a syntax of an instruction 310 for performing an action at an explicit time. The instruction 310 employs four parameters to specify the desired semantics. The parameter “action A” 312 specifies the action to be triggered, and the parameter “time T_{S}” 314 specifies an explicit time T_{S} when the trigger is to be generated for the action A. The instruction 310 also adds the “Boolean cancel-if-late” parameter 316 and the “function callback-if-late” parameter 318. The “cancel-if-late” parameter 316 specifies whether the action A is to be performed or cancelled if time T_{S} has already passed when the scheduling occurs (T_{CLOCK}>T_{S}). Also, the “callback-if-late” function will be called if time T_{S} has already passed when the scheduling occurs.

The callback function of 310 is just one way for a programmer to choose whether to signal an error (for example, the programmer can pass in a function which does nothing, and that will have the effect of not signaling an error). FIG. 3B illustrates a second embodiment of a syntax of an instruction 320 for performing an action at an explicit time. The instruction 320 returns an error code through a parameter “was-late” 322.

In the embodiment as shown in FIG. 1, controller 120 schedules actions to be performed by instrument 140. In that case, FIG. 3C illustrates a third embodiment of a syntax of an instruction 330 to instrument 140 for performing an instrument function at an explicit time. The instruction 330 includes the “Boolean trigger-if-late” parameter 332 and the “InstrumentFunction perform-if-late” parameter 334. The “trigger-if-late” parameter 332 specifies whether or not instrument 140 is to perform an action A if time T_{S} has already passed when the scheduling occurs (T_{CLOCK}>T_{S}). Meanwhile, the “InstrumentFunction perform if late” parameter 334 specifies an instrument function to be performed by instrument 140 if time T_{S} has already passed when the scheduling occurs.

FIG. 3D illustrates a fourth embodiment of a syntax of an instruction 340 for performing an action at an explicit time. Like the instruction 330, the instruction 340 of FIG. 3D can be employed in a case where the action is to be performed by instrument 140. The instruction of FIG. 3D includes the “Boolean trigger-if-late” parameter 332, the “function callback-if-late” parameter 318, and the “InstrumentFunction perform-if-late” parameter 336. The instruction 340 provides flexibility in a single instruction for a programmer to: (1) specify a callback function for the controller 120 in the event that the trigger was late (or would have been late); and/or (2) specify a function to be performed by instrument 140 in the event that the trigger was late (or would have been late). The “trigger-if-late” parameter 332 specifies whether or not instrument 140 is to perform action A if time T_{S} has already passed when the scheduling occurs (T_{CLOCK}>T_{S}). Meanwhile, the “callback-if-late” 318 parameter specifies a function to be called if time T_{S} has already passed when the scheduling occurs. Finally, the “InstrumentFunction” parameter 336 specifies a function to be performed by instrument 140 if time T_{S} has already passed when the scheduling occurs.

Although FIGS. 3A-D illustrate four embodiments of instructions that provide semantics for a late-trigger situation, it is understood that other embodiments are possible.

Performing an instruction with semantics for handling late-triggering events, as described above, requires support at the hardware level. More specifically, support is needed to detect accurately whether an event is scheduled in the past. Accordingly, in one embodiment, an input and an output are added to triggering device 230 of FIG. 2. The input is used to tell whether to trigger if the clock time indicated by real-time clock 236 is already past the scheduled time for the action (T_{CLOCK}>T_{S}) when the “enable” bit is set, starting the triggering operation. The output tells whether the clock time indicated by real-time clock 236 was already past the scheduled time for the action (T_{CLOCK}>T_{S}) when the “enable” bit was set. This additional input and output allow four possibilities for what to do when an action is supposed to be performed at a time in the past, matching the four scenarios of Table 1, above.

Notice that even if the programmer does not want to signal an error (cases 2 and 4 in Table 1) the circuit still produces the ‘late’ output. The programmer can ignore this signal (by providing a null callback, by discarding a value returned through the action's name, or by ignoring the value returned through a parameter).

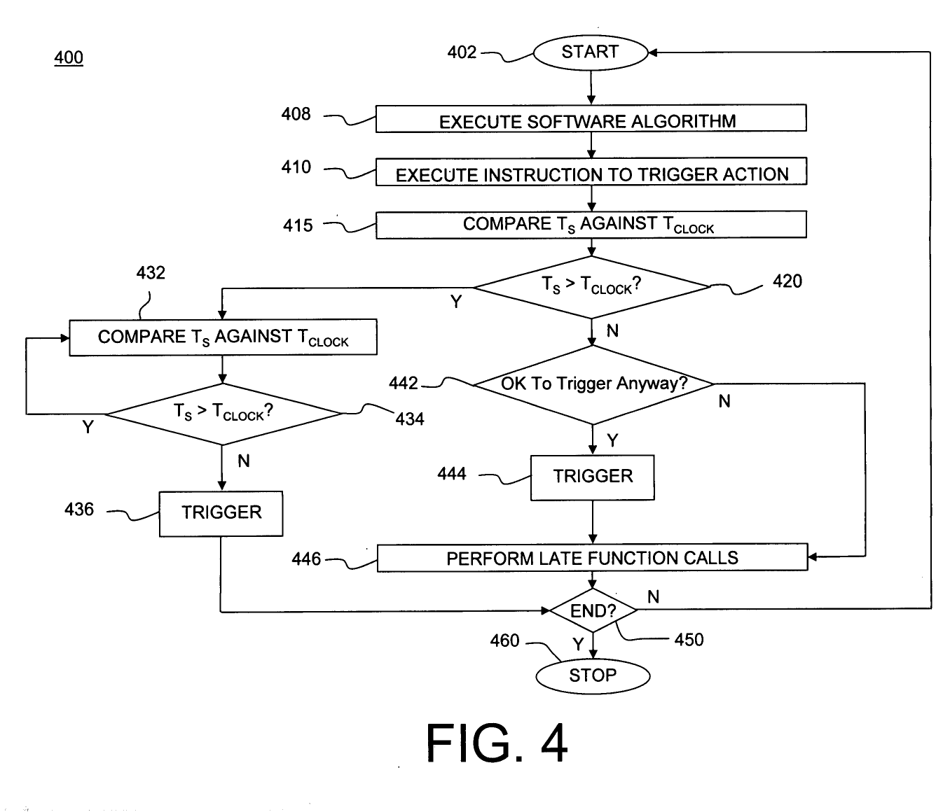

Assuming that the hardware support described above, or other provisions for handling late-triggering events, are provided, FIG. 4 is a flowchart illustrating one embodiment of an algorithm 400 employing an instruction for performing an action at an explicit time. In particular, the algorithm 400 may be employed by the system 100 to execute a desired process.

The process 400 starts in a first step 402. Then, in a step 408, a controller 120 begins a software algorithm and starts real-time clock 236. In the process 400, the software algorithm is written using a programming language configured to operate with real-time clock 236, and supports at least one instruction that specifies semantics for a late trigger. Subsequently, in a step 410, an instruction is called that specifies an action to be triggered at an explicit time. The instruction may conform to the syntax of any of the instructions illustrated in FIGS. 3A-D above, or may conform to some other embodiment.

In a step 415, the scheduled time for the action, T_{S}, is compared against clock time T_{CLOCK}.

In a step 420, it is determined whether the current time is too early for the action to be performed. If so, then the instruction has arrived in time, and the process proceeds to step 432. In step 420, as explained above, some means must be provided to insure that this test is only false once so that the trigger is only generated once, and not on every subsequent clock tick. In step 432, the algorithm continues to compare the scheduled time for the action, T_{S}, is compared against clock time T_{CLOCK}. In step 434, it is determined again whether the current time is still too early for the action to be performed. If so, then the algorithm returns to step 432, and the loop of steps 432 and 434 is repeatedly performed until it is that the current time is no longer too early for the action to be performed. At that point, the algorithm proceeds to step 436 where the trigger is executed. After the trigger is executed in step 436, then in a step 450 it is determined whether the process should begin again at step 402, or end in step 460.

On the other hand, if it is determined in step 420 that the specified explicit time for the action, T_{S}, has already passed, then in a step 442, in accordance with the specified late-trigger parameters of the instruction, it is determined whether the trigger should or should not be generated, and an error may or may not be processed, implementing any of the four scenarios of Table 1 above. If it is OK to trigger the event late, then in a step 444 the trigger is executed, and the process continues at a step 446. If it is not OK to trigger the event late, then the process continues at step 446 without executing the trigger. In the step 446, any function calls specified by the instruction are executed. Then, in the step 450 it is determined whether the process should begin again at step 402, or end in step 460.

Although the concepts disclosed herein have been described above in the context of a system including a controller and an instrument and a late event for an instruction for performing an action at an explicit time, it should be understood that the concepts extend to other contexts and syntactic forms. For example, Rule 4.4 of the Local Area Network eXtensions for Instrumentation (LXI) Standard, Revision 1.0 (23 Sep. 2005) (which is incorporated herein by reference) describes a network packet which may include action, time and parameters. It is possible to use such a network packet to provide an instruction to make a measurement at a time specified in the packet, or to set a parameter to a specified value at the time contained in the packet. In those cases, then the time specified in the packet is intended to be in the future, and thus the packet can be late. In accordance with the concepts described above, the parameters included in the packet may specify what to do in the event of a late packet, including whether or not to perform the instruction included in the packet. Other syntactic forms are also possible.

While example embodiments are disclosed herein, one of ordinary skill in the art appreciates that many variations that are in accordance with the present teachings are possible and remain within the scope of the appended claims. The embodiments therefore are not to be restricted except within the scope of the appended claims.

1. A method for controlling the activities of a computer-based instrument containing a real-time clock and running one or more software routines, the method comprising:
executing a software triggering routine controlling a specific hardware operation, wherein the software triggering routine is structured to receive one or more parameters specifying the semantics of the triggering routine, wherein the one or more parameters include at least one of:
a first parameter for specifying a specific error code of the software triggering routine should the real-time clock indicate that the computer-based instrument is late in executing the triggering routine; and
a first control parameter specifying whether the computer-based instrument will execute or cancel the specific hardware operation should the real-time clock indicate that the computer-based instrument is late in executing the software triggering routine.

2. The method of claim 1, wherein the one or more parameters further includes a first time parameter for specifying the specific time that the specific hardware operation should be executed.

3. The method of claim 1, wherein the one or more parameters includes both of the first error code parameter and the first control parameter.

4. The method of claim 3, wherein the one or more parameters further includes a first time parameter for specifying the specific time that the specific hardware operation should be executed.

5. The method of claim 1, wherein the specific hardware operation includes at least one of a data acquisition operation and a hardware control operation.

6. The method of claim 1, wherein the one or more parameters further includes a first hardware operation parameter for specifying the specific hardware operation.

7. The method of claim 1, wherein the one or more parameters further includes a function parameter containing information relating to a first software function containing a plurality of software instructions, wherein the first software function is to be executed should the computer-based instrument be late in executing the software triggering routine.

8. The method of claim 1, wherein the software triggering routine takes a syntactic form of at least one of a subroutine and a function.

9. The method of claim 8, wherein the software triggering routine includes an argument field containing at least a first argument corresponding to one of the one or more parameters.

10. In a computer programming language environment operating with a real-time clock, a method comprising:
providing an instruction in the programming language for performing an action and for specifying an explicit time for performing the action, the instruction including at least a first parameter for specifying whether the action should be performed in a case where the real-time clock indicates that the specified explicit time when the action is to be performed has passed; and
providing a means for at least one of (1) signaling an error, and (2) specifying a function to be performed, in a case where the real-time clock indicates that the specified explicit time when the action is to be performed has passed.

11. The method of claim 10, wherein the means for signaling an error comprises a callback function to be called in a case where the real-time clock indicates that the specified explicit time when the action is to be performed has passed.

12. The method of claim 10, wherein the means for signaling an error comprises a second parameter of the instruction having a Boolean value.

13. The method of claim 10, wherein the means for specifying a function to be performed comprises a function to be performed by an instrument in a case where the real-time clock indicates that the specified explicit time when the action is to be performed has passed.

14. A computer-based system, comprising:
memory; and
a processor configured to execute one or more algorithms in response to instructions stored in the memory and written using a programming language configured to operate with a real-time clock, the algorithm including:
an instruction in the programming language for performing an action and for specifying an explicit time for performing the action, the instruction including at least a first parameter for specifying whether the action should be performed in a case where the real-time clock indicates that the specified explicit time when the action is to be performed has passed; and
a means for at least one of (1) signaling an error, and (2) specifying a function to be performed, in a case where the real-time clock indicates that the specified explicit time when the action is to be performed has passed.

15. The system of claim 14, wherein the means for signaling an error comprises a callback function to be called in a case where the real-time clock indicates that the specified explicit time when the action is to be performed has passed.

16. The system of claim 14, wherein the means for signaling an error comprises a second parameter of the instruction having a Boolean value.

17. The system of claim 14, wherein the means for specifying a function to be performed comprises a function to be performed by an instrument in a case where the real-time clock indicates that the specified explicit time when the action is to be performed has passed.

18. The system of claim 14, further comprising a triggering device for performing a triggering operation for performing the action, the triggering device including:
an input adapted to receive a signal indicating whether to trigger in a case where the real-time clock indicates that the specified explicit time when the action is to be performed has passed at a time when the triggering operation is enabled; and
an output adapted to output a signal indicating whether the real-time clock indicated that the specified explicit time when the action is to be performed had passed at the time when the triggering operation was enabled.

19. In a system operating with a real-time clock, a method comprising:
providing an instruction for performing an action and for specifying an explicit time for performing the action, the instruction including at least a first parameter for specifying whether the action should be performed in a case where the real-time clock indicates that the specified explicit time has passed when the action is scheduled to be performed; and
providing a means for at least one of (1) specifying whether the action should be performed, and (2) specifying any other action to be taken, in a case where the real-time clock indicates that the specified explicit time when the action is to be performed has passed.

20. The method of claim 19, wherein the instruction is provided in a packet communicated within the system from a first device to a second device.
